(19) United States
(12) Patent Application Publication
(10) Pub. No.: US 2026/0161361 A1
(43) Pub. Date: Jun. 11, 2026

(54) PROCESSOR, METHOD, AND SYSTEM FOR TENSOR TRANSPOSE FOR MACHINE LEARNING

(71) Applicant: MOFFETT INTERNATIONAL CO., LIMITED, Kowloon (HK)

(72) Inventor: Changxu ZHANG, Santa Clara, CA (US)

(21) Appl. No.: 18/976,834

(22) Filed: Dec. 11, 2024

(51) Int. Cl. G06F 7/78

(52) U.S. Cl. CPC G06F 7/78

(57) ABSTRACT

The present invention relates to a processor designed to optimize memory bandwidth utilization for tensor transpositions in machine learning. It features an instruction decoder that decodes tensor transpose instructions for an input tensor, distinguishing between transposing and stationary axes. An inner transpose engine, equipped with multiple tensor buffer units of varying sizes, transposes the tensor by reading data by rows and writing by columns, efficiently managing memory when the buffer is full. Additionally, an address scheduler determines the target memory addresses in the output tensor memory for the tensor data, improving the handling and transformation of tensors in machine learning environments. This processor significantly enhances the efficiency and speed of tensor operations critical to advanced machine learning applications.

### TECHNICAL FIELD

The disclosure generally relates to a hardware design for tensor transposition in machine learning models, in particular, a circuit that supports tensor transposition with element-level granularity.

### BACKGROUND

In the realm of machine learning and deep learning, tensor transposition is pivotal for data manipulation, playing a vital role in the preprocessing, data augmentation, and adaptation of data to fit neural network architectures. This process, which entails the rearrangement of multidimensional tensor dimensions, is critical for enhancing the training and inference efficiency of models. However, the computational infrastructure, including Central Processing Unit (CPUs) and Graphic Processing Unit (GPUs), currently falls short in efficiently addressing the intricate memory access and reshuffling demands that tensor transposition introduces.

This deficiency in hardware capability leads to significant inefficiencies, particularly as the complexity and dimensionality of tensors grow. The inability of hardware to adeptly handle the non-linear data access patterns required for tensor transposition results in less-than-optimal use of cache memory and an escalation in memory bandwidth needs. Such inefficiencies not only slow down the computational process but also widen the disconnect between existing hardware designs and the sophisticated requirements of contemporary machine learning tasks.

### SUMMARY

Various embodiments of the present specification may include processors and systems for improving the memory access efficiency during tensor transposition operations.

In one aspect, this specification describes a circuit for optimizing hardware resource utilization during tensor transposition in neural network computation. The circuit may include a first data reshuffle circuit configured to: receive an input tensor subject to tensor transposition as part of the neural network computation; divide the input tensor into tensor segments; and evenly distribute the tensor segments to a plurality of transpose memory arrays for parallel transposition; and the plurality of transpose memory arrays configured to perform the parallel transposition of the tensor segments, wherein each of the plurality of transpose memory arrays comprises a two-dimensional array of memory cells; a second data reshuffle circuit configured to: receive transposition results of the tensor segments from the plurality of transpose memory arrays; and reorganize the transposition results to generate a transposed version of the input tensor.

In some embodiments, the plurality of transpose memory arrays comprise a plurality of 16 by 16 two-dimensional array of memory cells, each memory cell storing 8 bits of data.

In some embodiments, the plurality of transpose memory arrays comprise four transpose memory arrays.

In some embodiments, each of the memory cells in the plurality of transpose memory arrays has a first bit-depth, each piece of tensor data in the input tensor has a second bit-depth, the second bit-depth is equal to or greater than the first bit-depth.

In some embodiments, to divide the input tensor into the tensor segments, the first data reshuffle circuit is further configured to divide each piece of tensor data in the input tensor into tensor elements having the first bit-depth.

In some embodiments, each of the tensor segments has a data width equal to a product of the first bit-depth and a number of the plurality of the transpose memory arrays.

In some embodiments, to evenly distribute the tensor segments to the plurality of transpose memory arrays, the first data reshuffle circuit is further configured to: assign the tensor elements in each tensor segment to the plurality of transpose memory arrays in a round robin manner.

In some embodiments, the first bit-depth and the second bit-depth are selected from 8 bits, 16 bits, and 32 bits.

In some embodiments, the input tensor comprises a first dimension and a second dimension selected from 16, 32, and 64.

In some embodiments, the parallel transposition of the tensor segments are performed in a plurality of iterations, each iteration comprising a plurality of loading cycles followed by a plurality of storing cycles.

In some embodiments, during each iteration: the plurality of transpose memory arrays read one or more grids of tensor data of the input tensor from a memory and transpose the one or more grids of tensor data in parallel.

In some embodiments, during each of the plurality of loading cycles, the tensor data being transposed is read from a memory in a stride-skipping pattern.

In some embodiments, during each of the plurality of storing cycles, the tensor data in the transposition results is written into a memory in a stride-skipping pattern.

In some embodiments, during each of the plurality of loading cycles, the plurality of transpose memory arrays are fully filled with tensor data of the input tensor read from a memory.

In some embodiments, during each iteration, each of the plurality of transpose memory arrays performs intra-grid transposition in each of the one or more grids of tensor data, and the circuit further comprises a control module to perform inter-grid transposition among the one or more grids of tensor data.

In some embodiments, to reorganize the transposition results to generate the transposed version of the input tensor, the second data reshuffle circuit is configured to: after the parallel transposition performed by the plurality of transpose memory arrays, sequentially aggregate data from corresponding memory cells across the plurality of transpose memory arrays, generating partial results at each memory cell, and aggregate the partial results to form the transposed version of the input tensor.

In another aspect, this specification describes a method, including: receiving an input tensor subject to tensor transposition as part of neural network computation; dividing the input tensor into tensor segments; evenly distributing the tensor segments to a plurality of transpose memory arrays for parallel transposition; performing the parallel transposition of the tensor segments, wherein each of the plurality of transpose memory arrays comprises a two-dimensional array of memory cells; receiving transposition results of the tensor segments from the plurality of transpose memory arrays; and aggregating the transposition results to generate a transposed version of the input tensor.

In some embodiments, the plurality of transpose memory arrays comprise a plurality of 16 by 16 two-dimensional array of memory cells, each memory cell storing 1 byte of data or 8 bits of data.

In some embodiments, the plurality of transpose memory arrays comprise 4 transpose memory arrays.

In some embodiments, each of the memory cells in the plurality of transpose memory arrays has a first bit-depth, and each piece of tensor data in the input tensor has a second bit-depth, and the method further comprises: determining a quantity of data elements in each tensor segment based on the second bit-depth and the first bit-depth.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1A illustrates an example tensor transposition in machine learning.

FIG. 1B illustrates the inefficient memory bandwidth utilization of existing processors for tensor transposition.

FIG. 2 illustrates an exemplary architectural diagram of a hybrid tensor transpose circuit that supports both vector-level and element-level tensor transposition, in accordance with various embodiments.

FIG. 3 illustrates an exemplary diagram of element-level tensor transposition using the tensor transpose circuit, in accordance with various embodiments.

FIG. 4A illustrates a first example tensor transposition using the tensor transpose circuit, in accordance with various embodiments.

FIG. 4B illustrates the memory access pattern in the first example tensor transposition using the tensor transpose circuit, in accordance with various embodiments.

FIG. 5A illustrates a second example tensor transposition using the tensor transpose circuit, in accordance with various embodiments.

FIG. 5B illustrates the memory access pattern in the second example tensor transposition using the tensor transpose circuit, in accordance with various embodiments.

FIG. 6A illustrates a third example tensor transposition using the tensor transpose circuit, in accordance with various embodiments.

FIG. 6B illustrates the memory access pattern in the third example tensor transposition using the tensor transpose circuit, in accordance with various embodiments.

FIG. 7 illustrates an example method executed by tensor transpose circuit, in accordance with various embodiments.

### DETAILED DESCRIPTION

The concept of transposing extends beyond two-dimensional matrices to tensors, which are multidimensional arrays of numbers. Tensors are fundamental in various scientific fields, including physics, computer science, and engineering. A tensor's dimensions are often referred to as “axes” or “modes.” While the transpose of a two-dimensional matrix involves flipping elements across its main diagonal, transposing a tensor with more than two dimensions involves rearranging these dimensions, a process which can significantly alter the tensor's structure and the relationship between its elements.

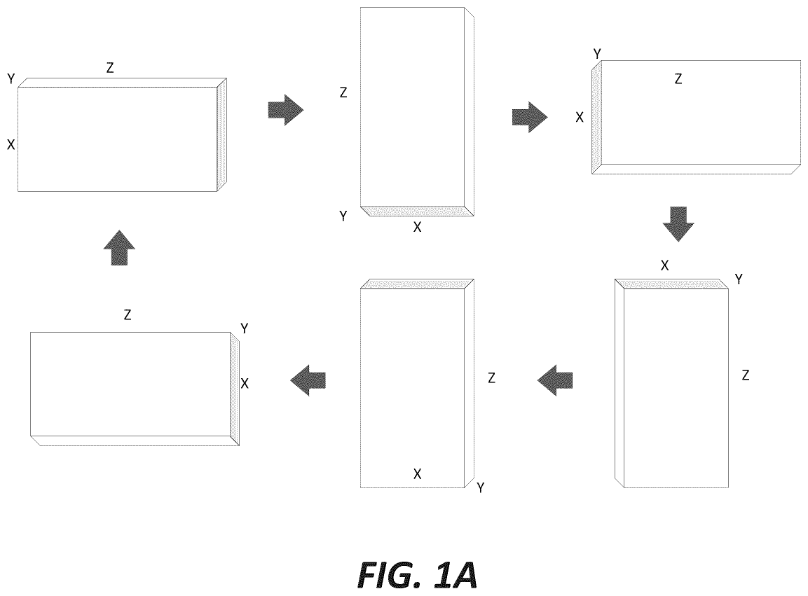

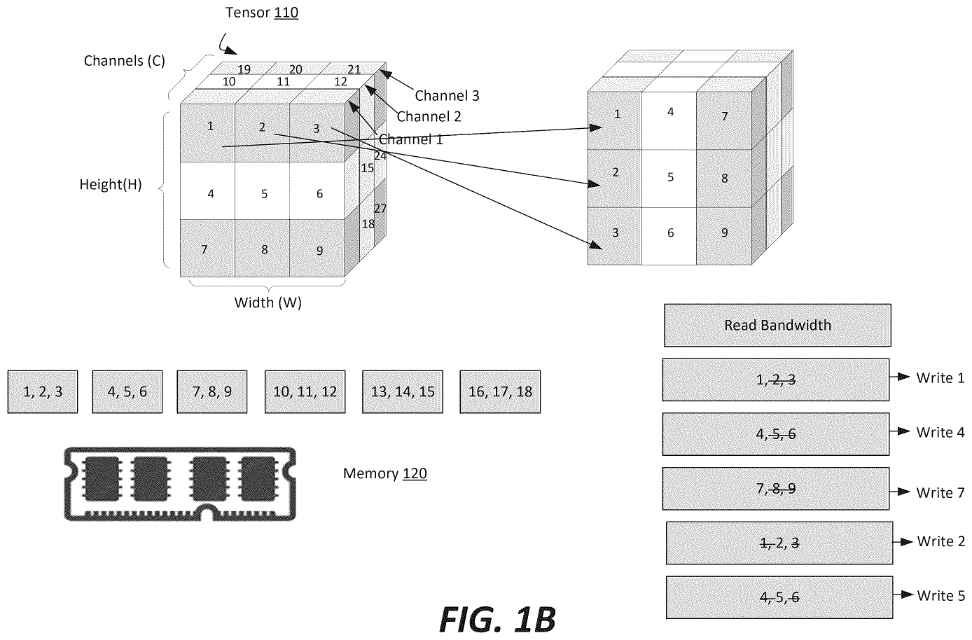

Transposition of a higher-dimensional tensor is defined by specifying a permutation of its dimensions. FIG. 1A illustrates an example tensor transposition in machine learning. The multi-dimensional tensor illustrated in FIG. 1A has three dimensions represented by (X, Y, Z), where X, Y, and Z denote the size of the tensor along each axis. In practice, each dimension X, Y, or Z may include more than one dimensions, meaning the multi-dimensional tensor could be more than three dimensions as illustrated in FIG. 1A.

Transposing the tensor in FIG. 1A might involve permuting these dimensions to (Z, X, Y), (Y, Z, X), or any other permutation, depending on the specific requirements of the operation being performed. This permutation changes how elements are indexed and accessed, effectively reshuffling the tensor's data.

The importance of tensor transposition is pronounced in fields like deep learning and computer graphics, where tensors are used to represent complex datasets such as images, videos, and multidimensional signal data. In these applications, transposing a tensor can be crucial for aligning data in a format expected by specific algorithms, for optimizing memory layout for faster computation, or for visualizing multidimensional data in a more interpretable manner.

One common application involves the transposition of a tensor representing an image. In computer memory, an image is often stored as a 3D tensor with dimensions corresponding to height, width, and color channels (e.g., RGB). Depending on the processing requirements, it may be necessary to transpose this tensor to align with the input format expected by image processing libraries or machine learning models, which might expect the color channels to be the first dimension rather than the last.

The flexibility in reordering the dimensions of a tensor during transposition allows for a versatile manipulation of multidimensional data, enabling more efficient data processing, analysis, and visualization. The specific manner in which tensor dimensions are permuted during transposition depends on the application's requirements, highlighting the operation's adaptability and broad utility across different scientific and engineering disciplines.

FIG. 1B illustrates the inefficient memory bandwidth utilization of existing processors for tensor transposition. As mentioned above, tensor transposition involves reordering the multi-dimensional tensors used widely in machine learning applications. When transposing tensors, traditional computing systems access memory by jumping to specific source addresses to fetch the required data segments and write to specific destination memory addresses directly. This process is inherently slow due to the non-sequential memory access patterns that arise when the axes of tensors are transposed. In the worst case, this might result in fetching only a single byte of effective data in each memory read cycle, leading to extremely low efficiency.

A naive approach to addressing this inefficiency is to increase the memory bandwidth, which allows the system to read as much data as possible in each cycle. However, this solution does not scale well with varying tensor transpositions, which may involve a large number of axes and each axis may have a large size. Since the tensor data is pre-stored in memory, transposing based on different axes results in varied and unpredictable memory access patterns. This variation makes it challenging to anticipate the amount of vector data needed for each transposition operation. Unless the entire tensor can be loaded into the cache simultaneously—which is impractical for large tensors—there will inevitably be inefficient reads during each cycle.

To illustrate, consider a scenario where a three-dimensional tensor [a, b, c] of size [64, 128, 512] bytes is stored such that every 512 bytes (the most-inner dimension) are stored sequentially in a memory with bandwidth of 512 bytes/cycle. If this tensor [a, b, c] is transposed to [b, a, c]—retaining the sequence of the inner-most dimension (called stationary axe) and transposing the two outer dimensions (a and b, called transposing axes)—the memory access pattern remains relatively efficient, allowing for the movement of 512 bytes of data per cycle. Here, the large, sequentially stored sections of data can be read in blocks, maximizing throughput.

However, if the inner-most dimension is not the largest, as in a tensor [a, b, c] sized [64, 128, 64] bytes transposed to [b, a, c] (i.e., swapping a dimension and b dimension), the most efficient bandwidth drops to 64 bytes per read cycle. This smaller bandwidth significantly reduces the throughput compared to the first example (i.e., only 64/512, or ⅛ of the memory bandwidth is effectively utilized).

The problem exacerbates further if the transposition involves the two most-inner dimensions, like transposing [a, b, c] sized [64, 128, 64] to [a, c, b] (i.e., swapping b dimension and c dimension). In such cases, there is no large block of sequentially stored data to fetch, potentially reducing throughput to as low as 1 byte per cycle if the inner dimensions are swapped, which represents a massive drop in efficiency.

FIG. 1B illustrates the above-described worst-case scenario using a 3×3 tensor 110, in which the height axis (H), the width axis (W), and the channel axis (C) are equal in size, and the channel dimension is typically the outermost, and the width dimension is the innermost, though the height could be innermost with similar outcomes. In practical applications, the channel dimension (C) is usually divided into a plurality of channel groups. Each channel group includes multiple contiguous channels, and denoted as channel group dimension. For example, there could be 128 channels, and every 16 channels are grouped together as a channel group. Usually, the channel group dimension is the inner-most dimension and the data within the same channel group is stored sequentially in memory. However, for simplicity, it is assumed that the channel group dimension is 1, therefore the W dimension becomes the inner-most dimension. The elements of tensor 110 are labeled to aid in explaining the transposition process and memory storage.

Commonly in existing technology, tensors are stored in memory 120 with the innermost dimension stored continuously first, followed by the next most-inner dimension, and so forth. As depicted in FIG. 1B, the sequence (1, 2, 3) from the channel 0 and height 0 row is stored consecutively in memory 120, followed by (4, 5, 6), (7, 8, 9), and so on.

If the transposition of tensor 110 involves swapping the height and width axes, while keeping the channel axis unchanged, the elements in channel 0 would be rearranged across its main diagonal post-transposition, as visualized in FIG. 1B.

During this transposition, assuming the system can read 3 bytes per cycle from memory, it would typically read data continuously from the initial memory address to fill the 3-byte capacity and then write this data to the designated memory location. In this case, during the first reading cycle, tensor data (1, 2, 3) is fetched using the 3 bytes/cycle bandwidth. However, from this data, only the first byte (1) is effectively fetched because only (1) is needed for the first row of the target tensor after transposition, rendering the remaining bytes (2, 3) unnecessary. Similarly, in subsequent cycles, only one byte per cycle is effectively used, such as (4) from the next set, making the memory bandwidth utilization efficiency only one-third, or 33%.

Some existing works identified that the primary reason for the above inefficiency arises from the row-based tensor read from the source memory and row-based tensor write to the target memory when handling both transposing and stationary axes in tensor transposition. To overcome such technical limitations, there are existing solutions that introduce a tensor transpose processor equipped with an inner transpose engine that executes row-based tensor reads and column-based tensor writes for the transposing axes. Previous works described in U.S. patent application Ser. No. 18/812/278, filed Aug. 22, 2024, and U.S. patent application Ser. No. 18/798,035, filed Aug. 8, 2024, are incorporated herein by reference.

However, these row-based or column-based transpose engine are designed to facilitate data movement with the granularity of vectors, i.e., the inner-most dimension of the tensor is treated as a vector for the transposition purposes. In other words, they do not support element-level tensor transposition, i.e., they could not transpose the last dimension of a tensor.

In practical use cases, there are scenarios where transposition at the granularity of individual elements is necessary. In modern models like Large Language Models (LLMs) and architectures that utilize self-attention mechanisms—such as the Transformer model—there is a critical need to transpose data at the element level, specifically within the channel dimension. The channel dimension refers to the last dimension of a tensor and often contains crucial feature representations. Transposing this dimension with any outer dimension is essential for the correct functioning of self-attention mechanisms, where relationships between different elements need to be modeled accurately.

For instance, during the computation of self-attention in Transformers, it's necessary to rearrange the channel dimension to align data properly for matrix multiplications and attention score calculations. Without the ability to transpose at the element level, the data cannot be efficiently reorganized to meet the computational requirements of these operations. This limitation leads to suboptimal performance and increases computational overhead, as additional steps or workarounds may be needed to achieve the desired data arrangement.

Therefore, the inability of existing transpose engines to handle the last dimension at an element-level granularity poses a significant bottleneck. The following description introduces an optimized transpose circuit capable of performing tensor transpositions at the element-level granularity. Such a circuit would address the limitations of previous designs by enabling fine-grained data rearrangement, thus improving the efficiency and flexibility of neural network inference.

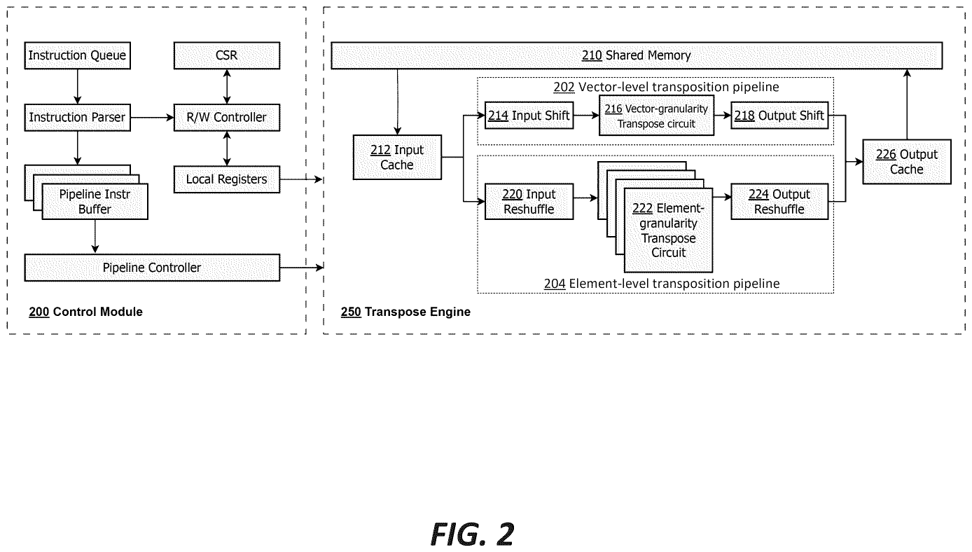

FIG. 2 illustrates an exemplary architectural diagram of a hybrid tensor transpose circuit that supports both vector-level and element-level tensor transposition, in accordance with various embodiments. The tensor transpose circuit is termed “hybrid” because it utilizes separate pipelines to handle vector-level and element-level tensor transpositions. These two pipelines can operate independently or in combination to perform tensor transpositions as part of neural network computations.

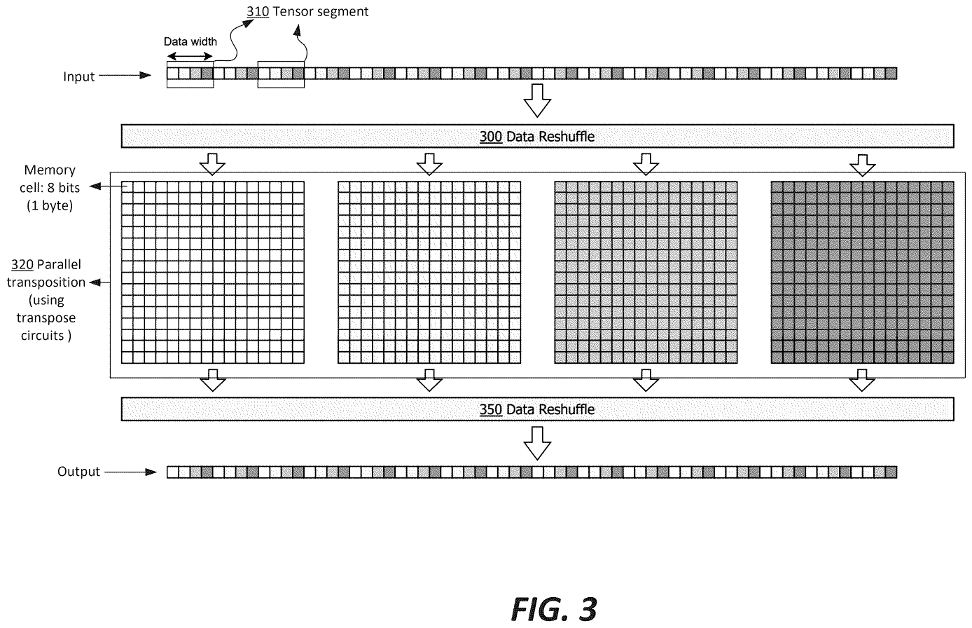

For simplicity of description, FIG. 3 illustrates two parts of the tensor transpose circuit, including a control module 200 and a transpose engine 250. In essence, the control module 200 is responsible for initializing, configuring, and managing data flow within the transpose engine 250, while the transpose engine 250 executes tensor transposition as directed by the control module 200.

In some embodiments, the control module 200 includes various components designed to manage and direct neural network computations, such as tensor transpositions. These components may include an instruction queue configured to receive computation instructions, such as memory addresses for input tensors, the type of computation to be performed, and the destination memory address for storing the output tensor. The control module 200 also comprises local (engine) registers, which serve as the interface for configuring the transpose engine 250, and an instruction parser for interpreting the instructions within the instruction queue. Additionally, the control module 200 includes a read/write controller that is used to get necessary data flow read/write control information from control/status registers(CSR) or instructions, a pipeline instruction buffer that acts as a staging area for buffering instructions, local registers that materialize the configurations specified by the engine, and pipeline controller responsible for executing the instructions fetched from the pipeline instruction buffer.

For example, the control module 200 may issue instructions to the transpose engine 250 to perform tensor transposition. The instructions may include a memory address for fetching the tensor from a shared memory 210, the transposition information (e.g., axes of the tensor for transposition), etc. In some cases, the transpose engine 250 may determine, based on the instructions, whether to activate the vector-level transposition pipeline 202 or the element-level transposition pipeline 204, or both. The vector-level transposition pipeline 202 is described in another U.S. Patent Application (e.g., FIG. 3C and corresponding descriptions in Application No. U.S. patent application Ser. No. 18/812/278), which is incorporated herein by reference. In particular, the vector-level transposition pipeline 202 may include an input shift buffer for input shifting 214, an output shift buffer for output shifting 218, and a vector-granularity transpose circuit 216 as a staging buffer for tensor transposition.

This disclosure focuses on the description of the element-level transposition pipeline 204. As shown in FIG. 2, the element-level transposition pipeline 204 includes three major components: an input reshuffle circuit 220 (denoted as 220 Input Reshuffle in FIG. 2), a group of element-granularity transpose circuits 222, and an output reshuffle 224 (denoted as 224 Output Reshuffle in FIG. 2).

In some embodiments, the input reshuffle circuit 220 is configured to receive an input tensor, subject to transposition, from the input cache 212. This input tensor refers to a two-dimensional sub-tensor segmented from an original high-dimensional tensor that is processed by the neural network, i.e., the input tensor represents the smallest unit undergoing tensor transposition. In most practical use cases, this input tensor has dimensions where each side is either 16, 32, or 64. That is, the input tensor comprises 16, 32, or 64 rows and 16, 32, or 64 columns. Each data element within this input tensor has a bit-depth indicating the number of bits used to represent it, which in modern neural network processors or accelerators may be 8 bits, 16 bits, or 32 bits.

The goal of the element-level transposition pipeline 204 is to transpose this input tensor, supporting any combination of tensor shapes (e.g., 16×16 , 16×32, 16×64, 32×32, 32×64, 64×64) and bit-depths of the tensor data. Critically, because the hardware resources in the element-level transposition pipeline 204 (especially the group of element-granularity transpose circuits 222) are expensive and limited, the transposition of input tensors with different shapes and data precisions must fully utilize these resources without leaving any component idle.

In some embodiments, the element-level transposition pipeline 204 includes a plurality of element-granularity transpose circuits 222 for performing parallel tensor transposition. The plurality of element-granularity transpose circuits 222 may include a predetermined number of identical 2-dimensional memory arrays with predetermined dimensions (referred to simply as memory arrays in the following descriptions).

For example, the number and dimensions of these identical memory arrays are determined based on the possible sizes of input tensors. As previously mentioned, the input tensor may range from as small as 16×16 to as large as 64×64. A straightforward approach is to use a single 64×64 memory array to accommodate the largest possible input tensor size. However, this design has a drawback: when the input tensor is smaller, such as 16×16, only a small portion of the 64×64 memory array is utilized, leading to inefficient use of hardware resources.

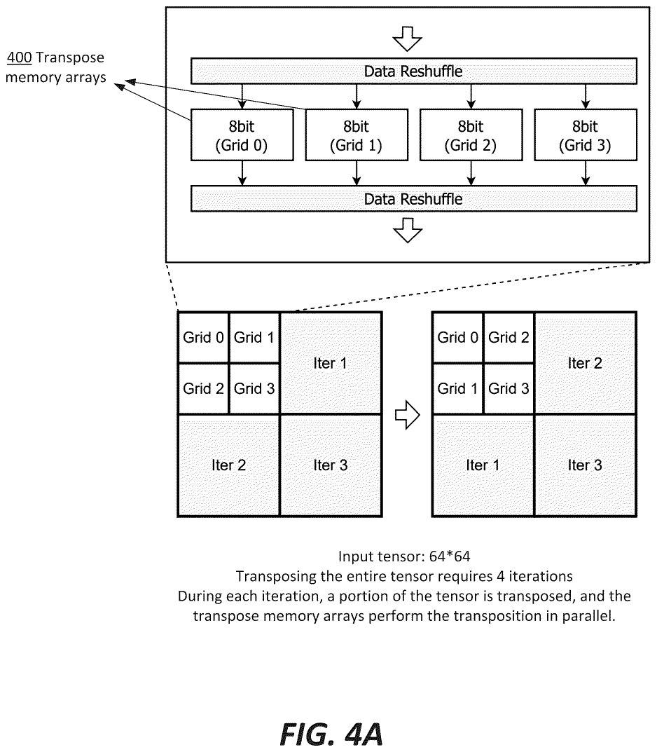

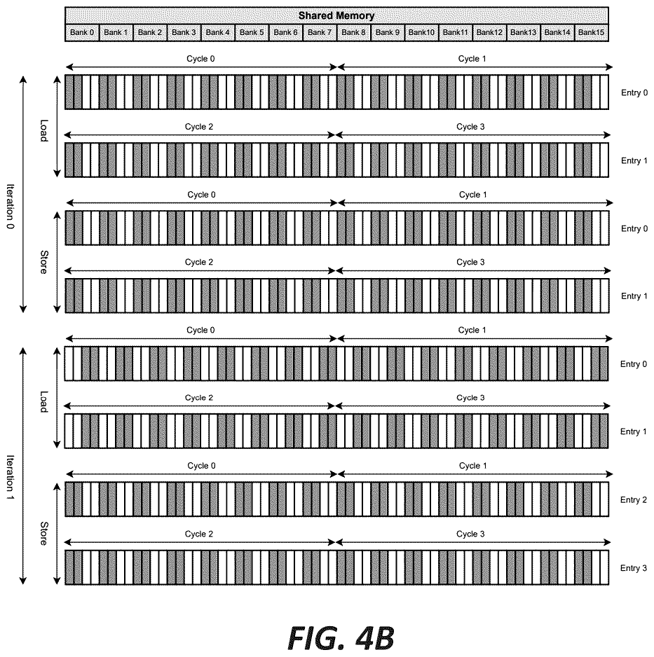

Therefore, the design illustrated in FIG. 2 includes four 16×16 memory arrays. This group of memory arrays works together to handle the transposition of any combination of tensor shapes (e.g., 16×16, 16×32, 16×64, 32×32, 32×64, 64×64) in parallel. During each transposition task, all the memory arrays are fully utilized, ensuring that no memory cell remains idle. FIGS. 4A through 6B illustrate example transpositions using the four 16×16 memory arrays.

Referring back to the input reshuffle circuit 220, it is configured to evenly distribute the tensor data in the input tensor among the plurality of memory arrays for parallel processing. In some cases, each of the memory cell in the memory arrays stores 8 bits of data (i.e., 1 byte), but the bit-depth of the tensor data in the input tensor may be greater than 8 bits, e.g., 16 bits or 32 bits. In these cases, a single tensor data may need to be distributed across multiple memory arrays to correctly perform the transposition. For example, if a tensor data element is 16 bits, it requires two memory cells for storage, each holding 8 bits. If these two 8-bit portions are stored in the same memory array—e.g., in two adjacent memory cells in the same row—the transposition operation will move them to two adjacent memory cells into the same column. When reading the data out of the memory array, these two adjacent memory cells in the column direction will not be recognized as representing the same tensor data element, leading to data corruption.

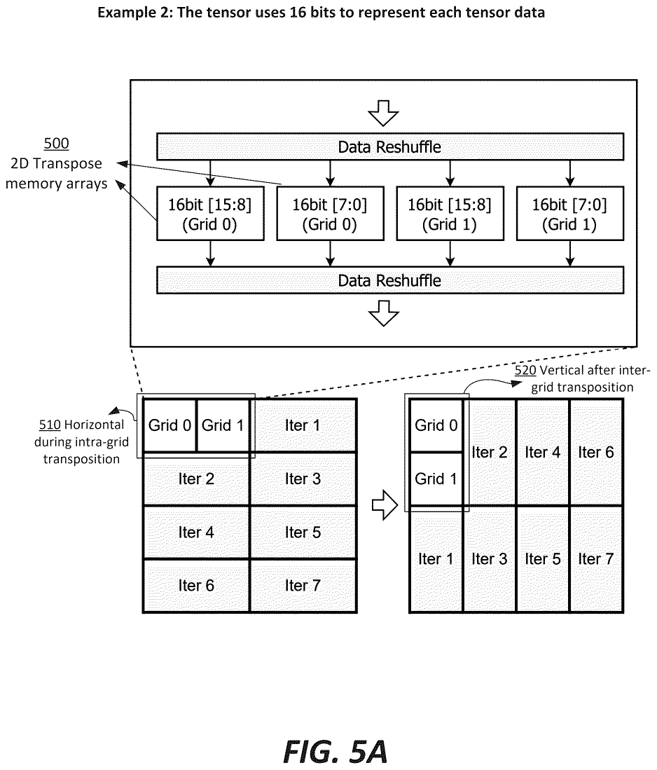

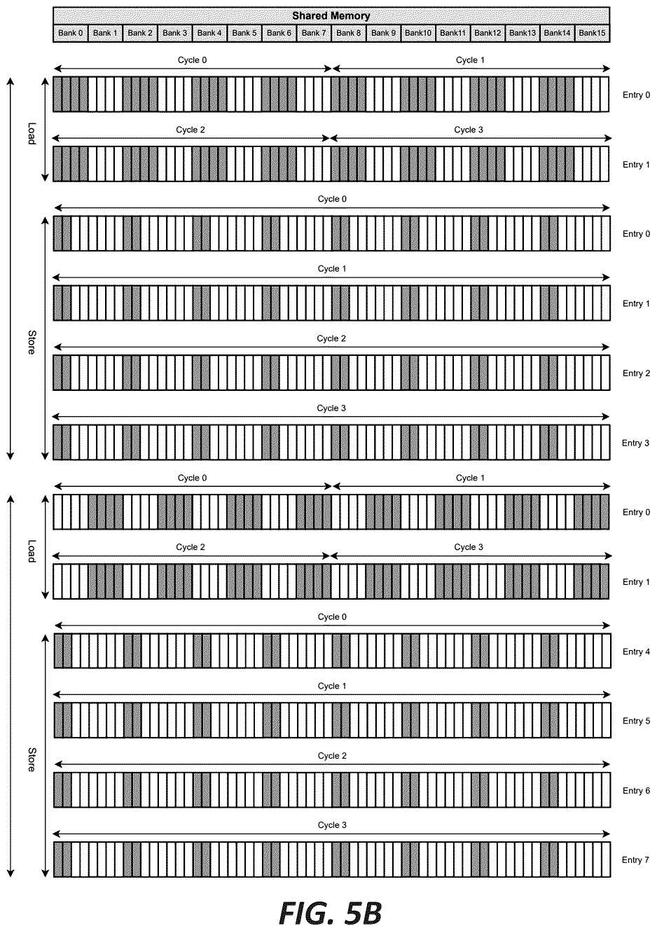

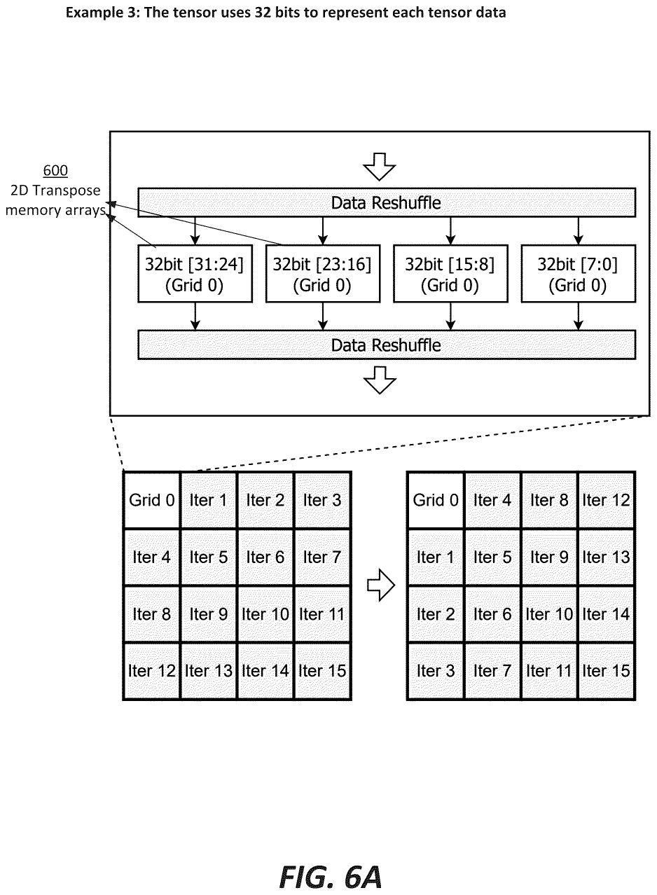

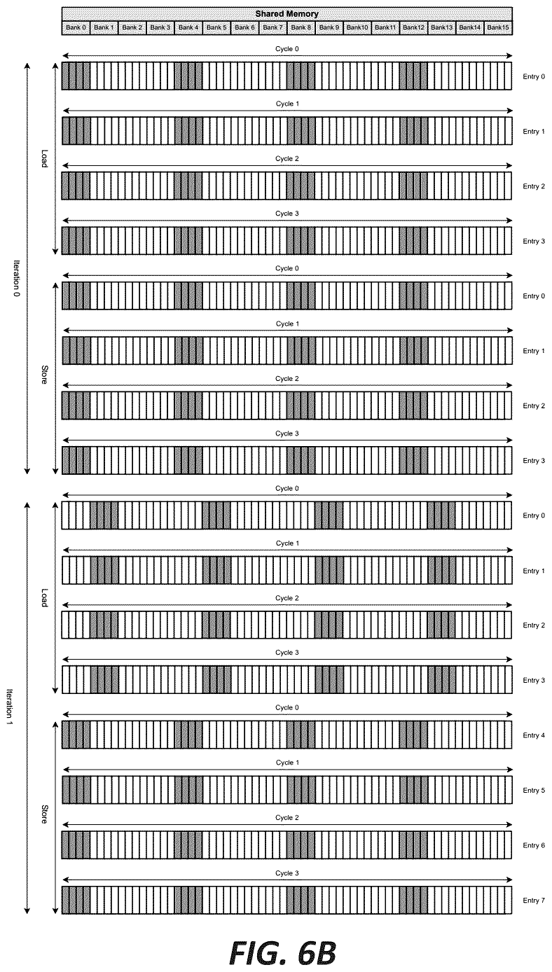

To address this issue, the input reshuffle circuit 220 divides the input tensor into tensor segments, where each tensor segment includes one or more tensor elements. These tensor elements are then evenly distributed among the memory arrays for parallel processing. Assuming there are four memory arrays and each memory cell stores 8 bits of data:
If the bit-depth of the tensor data in the input tensor is 8-bit, each tensor segment may include four tensor data (see FIGS. 4A-4B).
If the bit-depth of the tensor data in the input tensor is 16-bit, each tensor segment may include two tensor data (see FIGS. 5A-5B).
If the bit-depth of the tensor data in the input tensor is 32-bit, each tensor segment may include one tensor data (see FIGS. 6A-6B).

In other words, the number of tensor elements in each tensor segment is determined by the ratio between the bit-depth of the tensor data in the input tensor and the bit-depth of the memory cells in the memory arrays. In practice, the bit-depth of the memory cells is designed to be the smallest bit-depth required across all use cases; therefore, it is always less than or equal to the bit-depth of the tensor data in the input tensor.

Once the memory arrays are populated with tensor elements, parallel transposition is performed. The results of this parallel transposition form a portion of the final transposed tensor. To complete the transposition of the entire input tensor, multiple iterations of the parallel transposition may be necessary.

The output reshuffle circuit 224 is configured to reorganize and aggregate the transposition results generated by the memory arrays during these multiple iterations. The output from the output reshuffle circuit 224 is the transposed version of the input tensor, which may be written into an output cache 226 and subsequently stored back to the shared memory 210.

FIG. 3 illustrates an exemplary diagram of element-level tensor transposition using the tensor transpose circuit, in accordance with various embodiments. FIG. 3 includes the three major steps performed in the tensor transpose circuit: data reshuffle 300 on the input tensor (e.g., using the input reshuffle circuit 220 in FIG. 2), parallel transposition 320 using the element-granularity transpose circuit 222 in FIG. 2), and data reshuffle 350 to generate the output tensor using the output reshuffle circuit 224 in FIG. 2).

For simplicity, the input data in FIG. 3 is assumed to use 8 bits (or 1 byte) to represent a tensor data. The element-granularity transpose circuit includes four 16×16 two-dimensional (2D) memory arrays, with each memory cell storing 8 bits (1 byte). This configuration is used as an example to explain the data flow of the element-level tensor transposition. A person skilled in the art would understand how the data flow applies to other different configurations.

In some embodiments, the input tensor is first divided into tensor segments 310. Each tensor segment 310 includes a number of tensor elements equal to the number of 2D memory arrays in the transpose circuit, and each tensor element has the same bit-depth as a memory cell. This means that the data width of each tensor segment 310 is the product of the bit-depth of the tensor elements and the number of 2D memory arrays. In the example of FIG. 3, each tensor element is 8 bits (matching the bit-depth of the memory cells), and each tensor segment 310 includes four tensor elements (corresponding to the four 2D memory arrays).

Segmenting the input tensor in this way facilitates its distribution to the 2D memory arrays for parallel transposition. For instance, the tensor elements within each tensor segment 310 are assigned to the 2D memory arrays in a round-robin manner; that is, each 2D memory array receives one tensor element and stores it in one memory cell. After distributing the first tensor segment 310, the next tensor segment 310 is processed similarly. This process continues until all the 2D memory arrays are fully populated. Then, element-level transposition is performed in each of the 2D memory arrays in parallel. This process may be referred to as an iteration, and transposing the entire input tensor may require multiple iterations.

After the 2D memory arrays finish the element-level transposition, the resultant data may go through the output data reshuffle 350 to generate the output tensor, i.e., the transposed version of the input tensor.

FIG. 4A illustrates a first example tensor transposition using the tensor transpose circuit, in accordance with various embodiments. The example in FIG. 4A uses the same assumptions as FIG. 3, in which the input tensor uses 8-bit tensor data, and there are four identical transpose memory arrays 400 each with 8-bit memory cells. The diagram in FIG. 4A explains the parallel transposition from the perspective of an 64×64 input tensor, i.e., the input tensor has 64 rows and 64 columns of 8-bit tensor data.

As shown in FIG. 4A, transposing the input tensor requires four iterations: iteration 0, iteration 1, iteration 2, and iteration 3. During each iteration, the four 16×16 transpose memory arrays 400 are fully utilized. For example, during iteration 0, each of the 16×16 transpose memory arrays 400 transposes a 16×16 grid of the input tensor. Since each memory cell is 8 bits and stores one tensor data element, the four 16×16 transpose memory arrays 400 collectively transpose four grids (grid 0, grid 1, grid 2, and grid 3) of the input tensor. These four grids represent one-quarter of the entire input tensor.

It is important to note that during each iteration, the 16×16 transpose memory arrays 400 perform intra-grid transposition—that is, each memory array transposes the grid of tensor elements assigned to it. To achieve the overall global transposition, inter-grid transposition must also be performed. For example, grids 1 and 2 in FIG. 4A are transposed at the grid level to ensure correct placement of the tensor data in the final transposed tensor.

In this way, all the hardware resources—the 16×16 transpose memory arrays 400—are fully utilized during all iterations, with no memory cell left idle. Compared to using a single large 64×64 transpose memory array, this method of employing multiple smaller memory arrays enhances hardware resource efficiency at the expense of increased memory access complexity. However, this trade-off between hardware cost and speed is acceptable, considering that fast memory access renders the memory access latency negligible.

FIG. 4B illustrates the memory access pattern in the first example tensor transposition using the tensor transpose circuit, in accordance with various embodiments. The shared memory in this example uses memory banks to store the input tensor. A memory bank is a subdivision of memory that allows independent and parallel access, improving performance through increased bandwidth and reduced latency. Memory banks support random access within each bank, enabling both sequential and non-sequential read/write operations, with faster access when operations are within the same row (or page). Parallel read/write operations are supported across different memory banks, allowing simultaneous access to multiple banks and boosting overall system performance.

In the example shown in FIG. 4B, each memory bank stores 64 bytes of data. Each vertical rectangle in FIG. 4B represents 16 bytes of data, corresponding to the amount assigned to one row of one of the 16×16 two-dimensional (2D) memory arrays 400 in FIG. 4A (since each memory cell stores 1 byte and each row contains 16 memory cells, totaling 16 bytes).

As illustrated in FIG. 4B, during each iteration of transposition, there are multiple loading cycles in which the input tensor data are read from the shared memory into the 16×16 2D memory arrays (e.g., array 400 in FIG. 4A). Four cycles are required to fill the four 16×16 2D memory arrays. During each cycle, memory access follows a stride-skipping pattern. For example, in cycle 0, two sequential blocks of 16 bytes are read to fill the first row of the first two 2D memory arrays. The next two blocks of 16 bytes are skipped because they are scheduled for processing in iteration 1. This pattern continues over four cycles, ensuring that data for all four 2D memory arrays are loaded.

After the loading cycles, multiple storing cycles occur as part of the iteration. The storing pattern follows the same stride-skipping approach to write the transposed tensor elements from the 2D memory arrays.

FIG. 5A illustrates a second example tensor transposition using the tensor transpose circuit, in accordance with various embodiments. Different from the example in FIG. 4A, the input tensor in FIG. 5A is a 64×64 tensor with a bit-depth of 16-bit. Since each memory cell in the four 2D memory arrays 500 is 8-bit, each 16-bit tensor data needs two memory cells to store.

In this case, when segmenting the input tensor into tensor segments, each tensor element remains 8 bits to fit into one memory cell. Therefore, two 8-bit tensor elements are needed to represent one 16-bit tensor data. As a result, each tensor segment includes four tensor elements representing two 16-bit tensor data, consuming four memory cells across the four 2D transpose memory arrays 500. Each 8-bit tensor element is stored in one memory cell. Consequently, the first two 2D transpose memory arrays 500 are used to transpose the first grid (e.g., grid 0) of data from the input tensor, while the next two arrays handle the second grid (e.g., grid 1). Specifically, a 16-bit tensor data is split into its high 8 bits and low 8 bits, which are assigned to two different 2D transpose memory arrays 500, respectively.

Similar to the approach in FIG. 4A, the 2D transpose memory arrays 500 perform intra-grid transpositions. To achieve the global transposition of the input tensor, inter-grid transpositions must also be performed. For example, grids 0 and 1 in FIG. 5A are transposed at the grid level to ensure the correct placement of tensor data in the final transposed tensor.

The 2D transpose memory arrays 500 are fully utilized during each iteration. To transpose the 16-bit 64×64 input tensor, eight iterations are required. This is because each iteration transposes 4×16×16=1,024 bytes (or 8,192 bits), and the total size of the 16-bit 64×64 tensor is 8,192 bytes (or 65,536 bits).

FIG. 5B illustrates the memory access pattern in the second example tensor transposition using the tensor transpose circuit, in accordance with various embodiments. The shared memory in FIG. 5B is the same as the shared memory in FIG. 4B, involving memory banks each storing 64 bytes of data.

During each iteration of the transposition, there are four cycles for loading the tensor data into the 2D transpose memory arrays 500, and four cycles of writing the transposed data back to the shared memory. As shown in FIG. 5B, the data loading pattern here is different from the data storing pattern.

In particular, fulfilling the first row of all four 16×16 2D transpose memory arrays 500 needs 1 (byte per memory cell)×4 (memory arrays)×16 (16 memory cells in the first row in each memory array)=64 bytes. Therefore, the entire memory bank of 64 bytes is read in its entirety during the first iteration. Then the next memory bank is skipped because it is scheduled for transposition in the next iteration. Then the third memory bank is read to fulfill the second row of all four 16×16 2D transpose memory arrays 500. This stride-skipping pattern continues for four cycles to fully populate the 16 rows of the four 16×16 2D transpose memory arrays, i.e., each cycle populates 4 rows.

During storing cycles, the writing pattern also follows a stride-skipping pattern, but different from the stride-skipping pattern during loading phase. This is because when loading the tensor data, the two grids of data being transposed are two horizontal grids 510 (for intra-grid transposition) as shown in FIG. 5B. After the intra-grid transposition, the two grids go through inter-grid transposition and become vertically grids 520. When writing the two vertical grids, each row has two 2D transpose memory arrays 500 of data to write, i.e., 1 (bytes per memory cell)*16 (memory cells per array)*2=32 bytes (represented as two contiguous greyed rectangles). Then the rest of the data in the same row are not transposed and should be skipped, which will be handled in the next three iterations. Therefore, a total of 3×32=96 bytes of data, i.e., six rectangles in FIG. 5B, are skipped. This pattern continues until all grids 0 and 1 are written to the memory.

During iteration 1, a similar process is performed, except that the loading pattern now loads the second half of the 64 bytes in each row of the input tensor. The written pattern in iteration 1 is the same as the one in iteration 0.

FIG. 6A illustrates a third example tensor transposition using the tensor transpose circuit, in accordance with various embodiments. In this example, the input tensor is a 64×64 tensor with a bit-depth of 32 bits, i.e., each piece of tensor data is 32 bits. Since each memory cell in the four 2D memory arrays 600 is 8-bit, each 32-bit tensor data needs four memory cells to store. It means, one 32-bit tensor data will be split into four tensor elements (8-bit each) and assigned to the four 2D memory arrays 600 for transposition during each iteration.

As shown in FIG. 6A, during each iteration, one grid of data in the input tensor is being transposed. Each grid includes 16×16 tensor data.

FIG. 6B illustrates the memory access pattern in the third example tensor transposition using the tensor transpose circuit, in accordance with various embodiments. During iteration 0, there are four loading cycles and four storing cycles. During each loading cycle, a first full memory bank (64 bytes) is read in its entirety into the same row of the four 2D memory arrays 600 (4×16=64 bytes in each row). Then the next three memory banks are skipped because they will be processed in the next three iterations. This stride-skipping pattern continues until all rows of the four 2D memory arrays 600 are fulfilled.

During storing cycles, since there is only one grid being transposed during each iteration, the inter-grid transposition is a no-op, and the writing pattern is the same stride-skipping pattern as the loading phase.

During the next iteration, the loading cycles start to process the rest of the input tensor data, but the storing pattern stays the same (focusing on the one grid transposed during the current iteration).

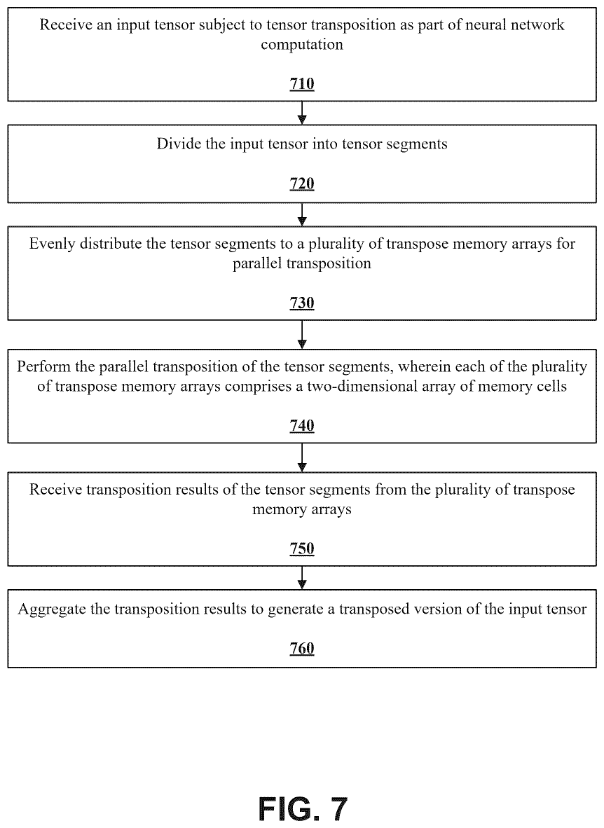

FIG. 7 is a flowchart of an example process 700. In some implementations, one or more process blocks of FIG. 7 may be performed by a circuit.

As shown in FIG. 7, process 700 may include receiving an input tensor subject to tensor transposition as part of neural network computation (block 710). For example, the circuit may receive an input tensor subject to tensor transposition as part of neural network computation, as described above.

As also shown in FIG. 7, process 700 may include dividing the input tensor into tensor segments (block 720). For example, the circuit may divide the input tensor into tensor segments, as described above.

As further shown in FIG. 7, process 700 may include evenly distributing the tensor segments to a plurality of transpose memory arrays for parallel transposition (block 730). For example, the circuit may evenly distribute the tensor segments to a plurality of transpose memory arrays for parallel transposition, as described above.

As also shown in FIG. 7, process 700 may include performing the parallel transposition of the tensor segments, where each of the plurality of transpose memory arrays may include a two-dimensional array of memory cells (block 740). For example, the circuit may perform the parallel transposition of the tensor segments, where each of the plurality of transpose memory arrays may include a two-dimensional array of memory cells, as described above.

As further shown in FIG. 7, process 700 may include receiving transposition results of the tensor segments from the plurality of transpose memory arrays (block 750). For example, the circuit may receive transposition results of the tensor segments from the plurality of transpose memory arrays, as described above.

As also shown in FIG. 7, process 700 may include aggregating the transposition results to generate a transposed version of the input tensor (block 760). For example, the circuit may aggregate and reorganize the transposition results to generate a transposed version of the input tensor, as described above.

Process 700 may include additional implementations, such as any single implementation or any combination of implementations described below and/or in connection with one or more other processes described elsewhere herein. In a first implementation, the plurality of transpose memory arrays may include a plurality of 16 by 16 two-dimensional array of memory cells, each memory cell storing 1 byte of data or 8 bits of data.

In a second implementation, alone or in combination with the first implementation, the plurality of transpose memory arrays may include 4 transpose memory arrays.

In a third implementation, alone or in combination with the first and second implementation, each of the memory cells in the plurality of transpose memory arrays has a first data width, and each piece of tensor data in the input tensor has a second data width, and the method further may include: determining a quantity of data elements in each tensor segment based on the second data width and the first data width.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training samples to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A circuit for optimizing hardware resource utilization during tensor transposition in neural network computation, comprising:
a first data reshuffle circuit configured to:
receive an input tensor subject to tensor transposition as part of the neural network computation;
divide the input tensor into tensor segments; and
evenly distribute the tensor segments to a plurality of transpose memory arrays for parallel transposition; and
the plurality of transpose memory arrays configured to perform the parallel transposition of the tensor segments, wherein each of the plurality of transpose memory arrays comprises a two-dimensional array of memory cells;
a second data reshuffle circuit configured to:
receive transposition results of the tensor segments from the plurality of transpose memory arrays; and
reorganize the transposition results to generate a transposed version of the input tensor.

2. The circuit of claim 1, wherein the plurality of transpose memory arrays comprise a plurality of 16 by 16 two-dimensional array of memory cells, each memory cell storing 8 bits of data.

3. The circuit of claim 1, wherein the plurality of transpose memory arrays comprise four transpose memory arrays.

4. The circuit of claim 1, wherein each of the memory cells in the plurality of transpose memory arrays has a first bit-depth, each piece of tensor data in the input tensor has a second bit-depth, the second bit-depth is equal to or greater than the first bit-depth.

5. The circuit of claim 4, wherein to divide the input tensor into the tensor segments, the first data reshuffle circuit is further configured to:
divide each piece of tensor data in the input tensor into tensor elements having the first bit-depth.

6. The circuit of claim 4, wherein each of the tensor segments has a data width equal to a product of the first bit-depth and a number of the plurality of the transpose memory arrays.

7. The circuit of claim 5, wherein to evenly distribute the tensor segments to the plurality of transpose memory arrays, the first data reshuffle circuit is further configured to:
assign the tensor elements in each tensor segment to the plurality of transpose memory arrays in a round robin manner.

8. The circuit of claim 4, wherein the first bit-depth and the second bit-depth are selected from 8 bits, 16 bits, and 32 bits.

9. The circuit of claim 1, wherein the input tensor comprises a first dimension and a second dimension selected from 16, 32, and 64.

10. The circuit of claim 1, wherein the parallel transposition of the tensor segments are performed in a plurality of iterations, each iteration comprising a plurality of loading cycles followed by a plurality of storing cycles.

11. The circuit of claim 10, wherein during each iteration:
the plurality of transpose memory arrays read one or more grids of tensor data of the input tensor from a memory and transpose the one or more grids of tensor data in parallel.

12. The circuit of claim 11, wherein, during each of the plurality of loading cycles, the tensor data being transposed is read from a memory in a stride-skipping pattern.

13. The circuit of claim 11, wherein, during each of the plurality of storing cycles, the tensor data in the transposition results is written into a memory in a stride-skipping pattern.

14. The circuit of claim 10, wherein, during each of the plurality of loading cycles, the plurality of transpose memory arrays are fully filled with tensor data of the input tensor read from a memory.

15. The circuit of claim 10, wherein, during each iteration, each of the plurality of transpose memory arrays performs intra-grid transposition in each of the one or more grids of tensor data, and the circuit further comprises a control module to perform inter-grid transposition among the one or more grids of tensor data.

16. The circuit of claim 1, wherein to reorganize the transposition results to generate the transposed version of the input tensor, the second data reshuffle circuit is configured to:
after the parallel transposition performed by the plurality of transpose memory arrays, sequentially aggregate data from corresponding memory cells across the plurality of transpose memory arrays, generating partial results at each memory cell, and
aggregate the partial results to form the transposed version of the input tensor.

17. A method, comprising:
receiving an input tensor subject to tensor transposition as part of neural network computation;
dividing the input tensor into tensor segments;
evenly distributing the tensor segments to a plurality of transpose memory arrays for parallel transposition;
performing the parallel transposition of the tensor segments, wherein each of the plurality of transpose memory arrays comprises a two-dimensional array of memory cells;
receiving transposition results of the tensor segments from the plurality of transpose memory arrays; and
aggregating the transposition results to generate a transposed version of the input tensor.

18. The method of claim 17, wherein the plurality of transpose memory arrays comprise a plurality of 16 by 16 two-dimensional array of memory cells, each memory cell storing 1 byte of data or 8 bits of data.

19. The method of claim 17, wherein the plurality of transpose memory arrays comprise 4 transpose memory arrays.

20. The method of claim 17, wherein each of the memory cells in the plurality of transpose memory arrays has a first bit-depth, and each piece of tensor data in the input tensor has a second bit-depth, and the method further comprises:
determining a quantity of data elements in each tensor segment based on the second bit-depth and the first bit-depth.
